(19) United States
(12) Patent Application Publication
(10) Pub. No.: US 2022/0324626 A1
(43) Pub. Date: Oct. 13, 2022

(54) COMPOSTABLE CAPSULES AND PRODUCTION AND USE THEREOF

(71) Applicant: DELICA AG, Buchs AG (CH)

(72) Inventors: Caroline SIEFARTH, Basel (CH); Roland AFFOLTER, Möriken (CH); Christopher BRUNSCHWILER, Baden (CH); Ralf VAN DER BRAGT, Sankt Pantaleon (CH); Selcuk YILDIRIM, Wädenswil (CH); Susanna MIESCHER, Zürich (CH); Annica FALLER, Meilen (CH)

(21) Appl. No.: 17/639,943

(22) PCT Filed: Sep. 4, 2020
(86) PCT No.: PCT/EP2020/074855

§ 371 Date: Mar. 3, 2022

(30) Foreign Application Priority Data
Sep. 5, 2019 (EP) 19195668.9

(51) Int. Cl. B65D 65/46; B65D 85/804; B65B 29/02

(52) U.S. Cl. CPC B65D 65/466; B65D 85/8043; B65B 29/022

(57) ABSTRACT

Compostable capsule for preparing a beverage, in particular a hot beverage, comprising
a core material of a bulk material, in particular selected from the group consisting of coffee powder, tea, cocoa, drinking chocolate, milk powder, instant coffee and dry soup and combinations thereof, and
a cladding material encasing the core material, wherein the cladding material is a compostable, non-crosslinked polysaccharide.

The present invention relates to compostable capsules comprising an ingredient suitable for the preparation of a beverage, in particular a hot beverage, and to the preparation and use thereof.

The provision of a luxury food such as coffee in capsule form is well known. However, the materials usually used as wrapping material, such as plastics or aluminium (cf. e.g. EP 2 106 375 A2), have the disadvantage that they are not compostable.

In DE 10 2014 000187 B4 it was proposed to coat a compact for the production of, for example, coffee with a coating material consisting of a biodegradable layer, said layer being a polysaccharide or a derivative thereof in combination with a polyol spacer and an associated crosslinker, i.e. a crosslinked polysaccharide. A specific example of an embodiment is not described.

EP 3 115 316 Bl describes a similar capsule for the production of, for example, coffee, whereby the cross-linked polysaccharide in the shell material was obtained without the use of a polyol spacer. Specifically, calcium alginate is mentioned as the shell material.

In US-2013/0136843 A1, it is proposed to coat a core of coffee powder with a shell of compacted coffee.

The aforementioned prior art solutions are not yet optimal in terms of providing a compostable capsule for the preparation of a hot beverage under the most economical, ecologically compatible and manufacturing reasons possible.

It was the object of the present invention to provide a compostable capsule for preparing a beverage, in particular a hot beverage, which overcomes the disadvantages of the prior art.

The task is solved by the subject-matter of the independent claims of the present application.

More specifically, the present invention relates to a compostable capsule for preparing a beverage, in particular a hot beverage, comprising
a core material of a bulk material, in particular selected from the group consisting of coffee powder, tea, cocoa, drinking chocolate, milk powder, instant coffee and dry soup and combinations thereof, and
a cladding material encasing the core material, wherein the cladding material is a compostable, non-crosslinked polysaccharide.

According to the present invention, “compostable” should be understood to mean that the material is at least home compostable according to the certification schemes NF T 51-800:2015-11-14 (Plastics—Specifications for plastics suitable for home composting) and AS 5810:2010 (Biodegradable plastics—Biodegradable plastics suitable for home composting). This means biodegradation of at least 90% of the material with release of CO2 within 12 months at a temperature of 25±5° C. and fragmentation (disintegration) of at least 90% of the material within 6 months at a temperature of 25±5° C.

The capsule according to the invention can have different shapes. A variety of such shapes are already known in the prior art for corresponding capsules in the relevant technical field. For example, the capsule may have the shape of an ellipsoid, a cylinder, a cone, a truncated cone, a cuboid, a cube, a coffee bean or a sphere. Preferably, the capsule is spherical.

The capsule according to the invention has a core-shell structure, i.e. a core of one material (core material) is surrounded by a shell of another material (cladding material). The shell may be formed without a seam if it is not assembled from several parts (such as hard capsules). However, the shell may also be formed from two or more parts. The shell may have a line of weakness at which it is easier to open the shell.

The capsule according to the present invention may contain a compact as core material. According to the present invention, a “compact” is understood to be a core material which has been compressed under pressure. The provision of the core material of the capsule as a compact is advantageous if the core material is sheathed according to the present invention by dipping, coating or spraying with the cladding material according to the present invention, so that it does not disintegrate during the sheathing process. The core material therefore preferably has a strength of at least 5 N, preferably in the range 5-50 N, more preferably in the range 5-20 N. This can preferably be achieved by performing the compression of the core material with a compression pressure in the range of 1-100 MPa, preferably 5-50 MPa. The resulting compact with shell then preferably has a strength in the range of 10-300 N, preferably 50-250 N, particularly preferably 75-225 N.

The compression pressure to be applied to produce the pellet depends on the properties of the core material, in the case of coffee powder, for example, on the grind, degree of roasting and moisture content of the powder. In the case of coffee powder in particular, it can be observed that powder with a smaller fat or oil content, e.g. decaffeinated coffee powder, requires a higher compression pressure in order to achieve a stable compact.

The strength of the compact is determined by clamping the compact between two plates and determining the force required to crush the compact. This method is also described in WO 2008/123775 A1, p.3.

According to the present invention, the core material is selected from the group consisting of coffee powder, tea, cocoa, drinking chocolate, milk powder, instant coffee and dry soup and combinations thereof. Such core materials are known and need not be discussed in detail herein. Solid and/or swellable materials have been shown to be advantageous over soluble materials because the material does not dissolve during beverage preparation and the capsule substantially retains its shape until beverage preparation is complete.

The cladding material to be used according to the invention is a compostable, non-crosslinked polysaccharide.

A non-crosslinked polysaccharide is understood to be a polysaccharide whose polymer chains are not linked to each other, or at most in traces, i.e. up to a degree of crosslinking of 5%, preferably at most 2%, particularly preferably at most 1%, with the aid of crosslinking agents.

Linking of polymer chains is generally understood to mean their connection to each other with the aid of a cross-linking agent. This includes conventional cross-linking with the formation of covalent bonds between the polymer chains and the cross-linking agent, but also coordinative linking, in which the polymer chains only form an ionic interaction via their functional groups with a cross-linking agent such as a polyvalent metal cation (such as calcium ions).

Cross-linking of the polysaccharide used can be prevented by not adding the reaction partners (cross-linking agents) required for cross-linking and/or by not applying the reaction conditions required for a cross-linking reaction (for example, presence of a required catalyst, a temperature required for cross-linking).

The cladding material is preferably designed in such a way that it does not dissolve during beverage preparation, in particular during the preparation of a hot beverage. During extraction with water at up to 100° C. and an extraction time of up to 3 min, the shell thus retains a stable shape so that the capsule can be ejected or removed from a beverage preparation machine without difficulty after beverage preparation.

The compostable non-cross-linked polysaccharide of the cladding material may be selected from the group consisting of starches, modified starches, pectins, celluloses, carrageenans, algin(at)es, especially sodium alginate, agar, pullulan, chitin, chitosan and combinations thereof.

Preferred according to the invention the compostable non-crosslinked polysaccharide of the cladding material is selected from the group consisting of carboxymethylcellulose (CMC), microfibrillated cellulose (MFC), sodium alginate, pullulan and chitosan and combinations thereof.

Carboxymethyl cellulose and microfibrillated cellulose have the following basic structure:

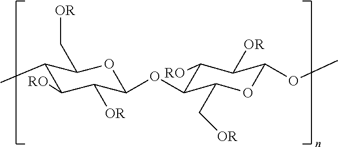

where in the case of carboxymethyl cellulose R═CH₂COOH, H and in the case of cellulose R═H. n (i.e. the number of monomers linked together in the chain) is usually chosen so that the carboxymethyl cellulose has a molecular weight in the range of about 10⁴ to 106 g/mol. The degree of substitution of the carboxymethyl cellulose (i.e. the proportion of hydroxy groups which are substituted with a carboxymethyl group) should preferably be in the range of 60-95% according to the invention.

Carboxymethyl cellulose and microfibrillated cellulose are commercially available and their production is known.

Sodium alginate is a polysaccharide with the following structure:

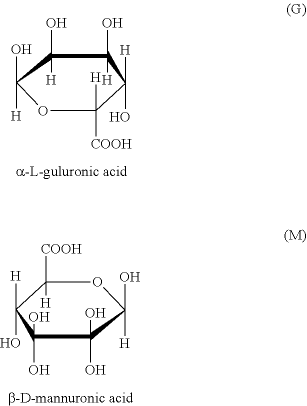

Sodium alginate is a polysaccharide consisting of the two uronic acids α-L-guluronic acid (GulUA) and β-D-mannuronic acid (Man-UA), which are 1,4-glycosidically linked in alternating proportions to form linear chains. It forms homopolymeric domains in which mannuronic acid or guluronic acid are present as blocks. These blocks are called GG or MM blocks.

Sodium alginate is commercially available and its production is well known.

Pullulan is a polysaccharide with the following structure:

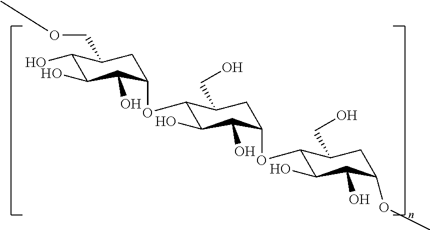

Pullulan and its production is well known. Pullulan is commercially available.

Chitosan is a polysaccharide with the following structure:

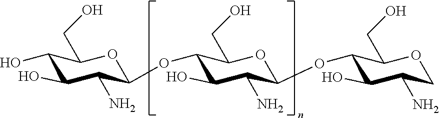

The value for n is usually about 2000. Chitosan and its production is known. Chitosan is commercially available.

The compostable non-cross-linked polysaccharide of the cladding material may comprise additional additives to modify the properties of the cladding material. For example, plasticisers such as glycerol, sorbitol, polyethylene glycol (PEG) or a combination of these plasticisers. Celluloses and cellulose derivatives are also conceivable additives, which serve in particular to increase stability.

The production of the capsule according to the invention can be carried out in the usual way by coating a compact of the desired core material with the cladding material in the usual way, in particular by dipping, coating or spraying.

The present invention thus also relates to a method for producing a compostable capsule according to the preceding description, comprising the steps of
a) Providing a core material selected from the group consisting of coffee powder, tea, cocoa, drinking chocolate, milk powder, instant coffee and dry soup and combinations thereof,
b) Compacting the core material into a compact,
c) Providing a system, in particular an aqueous system, comprising a compostable, non-crosslinked polysaccharide,
d) Application of the system, in particular the aqueous system, to the surface of the pressed part, in particular by dipping, coating or spraying,
e) Drying of the coated pellet,

the process being carried out under non-cross-linking conditions.

The compostable non-crosslinked polysaccharide may be selected from the group as listed above.

The compression of the core material into the shape of a pellet is known and has already been described above.

The provision of a system, in particular an aqueous system, comprising a compostable, non-cross-linked polysaccharide may be carried out in a customary manner by mixing a solution, in particular an aqueous solution, with the corresponding polysaccharide. The mixing may be assisted or facilitated by conventional measures such as stirring, heating, adjusting the pH range to increase the solubility of the polysaccharide, for example by adding an acid or base, or a combination of such measures.

In this context, a system is not only understood to be an aqueous system (i.e. a system comprising exclusively water as solvent). It is also conceivable that the system is a solvent mixture of water and a water-miscible solution, for example of low-chain (e.g. C₁₋₈), physiologically acceptable alcohol, such as ethanol. It is also conceivable that a coffee extract, for example from a brewed coffee or from an instant coffee, is used instead of water as a solvent to create the aqueous system.

In this way, a system is provided in the form of a solution, in particular an aqueous solution, with a concentration of compostable non-crosslinked polysaccharide of between 0.1% and 30% w/w, preferably between 1% and 20% w/w, more preferably between 3% and 6% w/w, based on the total weight of the system.

According to the invention, preferably a system is provided in the form of a solution, in particular an aqueous solution, with a concentration of carboxymethylcellulose between 1% and 10% w/w, preferably between 2% and 6% w/w, particularly preferably between 3% and 5% w/w, based on the total weight of the system.

According to the invention, it is further preferred to provide a system in the form of a solution, in particular an aqueous solution, having a concentration of microfibrillated cellulose between 0.1% and 5% w/w, preferably between 0.2% and 2% w/w, more preferably between 0.5% and 1.5% w/w, based on the total weight of the system.

According to the invention, it is further preferred to provide a system in the form of a solution, in particular an aqueous solution, with a concentration of sodium alginate between 1% and 5% w/w, preferably between 1.2% and 2.5% w/w, more preferably between 1.5% and 2% w/w, based on the total weight of the system.

According to the invention, it is further preferred to provide a system in the form of a solution, in particular an aqueous solution, with a concentration of pullulan between 1% and 30% w/w, preferably between 5% and 30% w/w, more preferably between 15% and 20% w/w, based on the total weight of the system.

According to the invention, it is further preferred to provide a system in the form of a solution, in particular an aqueous solution with a concentration of chitosan between 1% and 20% w/w, preferably between 1% and 10% w/w, particularly preferably between 3% and 8% w/w, based on the total weight of the system.

According to a preferred embodiment, softened or demineralised water is used for the step of providing an aqueous system comprising a compostable, non-crosslinked polysaccharide.

The system may include additional additives to modify the properties of the coating material to be applied. For example, plasticisers such as glycerol, sorbitol, polyethylene glycol (PEG) or a combination of these plasticisers. Such additives are usually added to the system in amounts of 0.1 to 8% w/w, preferably 0.2 to 3.6% w/w and more preferably 0.5 to 2% w/w, based on the total weight of the system.

The system provided in this way can be applied to the surface of the pressed part in the usual way, in particular by dipping, coating or spraying. Such processes are well known.

In accordance with the invention, the coating of the desired core material with the cladding material is preferably carried out by immersing the compact in the system described above. For example, the compact can be introduced into the system via a suitable suspension, where it remains for a desired time, for example for 1 to 60 s, preferably 2 to 30 s, particularly preferably 3 to 10 s. Other methods for coating in an immersion bath, for example with a fixed position in the immersion bath or a rolling movement through the immersion bath, are conceivable.

Subsequently, the compact, which is surrounded (i.e. coated) with cladding material on its surface, is removed from the system.

According to a preferred embodiment of the present invention, the cladding material is composed of 1-20 layers, preferably 2-10 layers and more preferably 2-5 layers, wherein the layers may be composed of the same or different compostable non-crosslinked polysaccharides.

Should it be desired to provide a cladding material comprising multiple layers, the step of coating the compact is carried out repeatedly using the same system or different systems to provide 1-20 layers, preferably 2-10 layers and more preferably 2-5 layers, on the surface of the compact. The type of coating process can also be the same, or alternatively different coating processes can be used.

The coated compact is subjected to a drying process after the last coating step and/or between one or more individual coating steps. This drying can be carried out in a conventional manner. According to the invention, drying is preferably carried out in an air stream, by convection and/or contact drying. Examples are tray drying with hot air and IR drying (drying by irradiation with IR radiation). The temperatures used for this are usually in the range of 10° C. up to 40° C. at normal pressure, preferably 15 to 25° C., usually below 50° C.

The process steps of coating and drying together usually require a duration of 2 to 20 min, preferably 5 to 10 min.

According to one embodiment of the present invention, the coating of the compact and the subsequent drying can be carried out in one process step if the coating is carried out in a known manner by a spray coating in a fluidised bed process. The temperatures applied for this are usually in the range of 25 to 40° C.

The above process according to the invention is carried out under non-crosslinking conditions. As stated above, the cladding material of the capsule according to the invention consists of a non-crosslinked polysaccharide, i.e. a polysaccharide whose polymer chains are not linked to each other, or at most in traces, i.e. up to a degree of crosslinking of 5%, preferably at most 2%, particularly preferably at most 1%, with the aid of crosslinking agents.

Linking of polymer chains is generally understood to mean their connection to each other with the aid of a cross-linking agent. This includes conventional cross-linking with the formation of covalent bonds between the polymer chains and the cross-linking agent, but also coordinative linking, in which the polymer chains only form an ionic interaction via their functional groups with a cross-linking agent such as a polyvalent metal cation (such as calcium ions).

Cross-linking of the polysaccharide used can be prevented by working under non-cross-linking conditions. According to the invention, this means that the reaction partners (cross-linking agents) required for cross-linking are not added and/or the reaction conditions required for a cross-linking reaction (for example, presence of a required catalyst, temperature required for cross-linking) are not applied.

The capsule according to the invention can be used to prepare a beverage, in particular a hot beverage, selected from the group comprising coffee, tea, cocoa, drinking chocolate, milk or soup, or combinations thereof.

According to the invention, it is preferred that the beverage is prepared by extracting the compostable capsule with an especially hot liquid selected from the group consisting of water and milk.

Corresponding preparation methods and devices for this are known from the state of the art.

### EXAMPLE 1

A spherical compact for coffee preparation was prepared by compacting 7 g of roasted ground coffee powder at 30 MPa in a press. The coffee powder had a moisture content of 3.5%. The mean particle size of the coffee powder was 400 μm±100 μm. An aqueous solution of demineralised water and carboxymethylcellulose (CMC) (CMC sodium salt, medium viscosity, C4888, Sigma Al-drich, Switzerland) was then prepared. A system was prepared in the form of an aqueous solution with a concentration of carboxymethylcellulose (CMC) of 4% w/w based on the total weight of the aqueous solution. The solution was then mixed with 40% w/w sorbitol (based per gram dry weight of CMC). The pellet was immersed in the aqueous CMC solution for 6 s and dried for approx. 6 min at 25° C. in an air stream. Subsequently, the pellet was immersed a second time for 6 s in the aqueous CMC solution and again dried for approx. 6 min at 25° C. in an air stream.

### EXAMPLE 2

A spherical compact for coffee preparation was prepared by compacting 6 g of roasted ground coffee powder at 30 MPa in a press The coffee powder had a moisture content of 3%. The mean particle size of the coffee powder was 400 μm±100 μm. Subsequently, an aqueous solution of demineralised water and sodium alginate (VIVAPUR Sodium Alginate, medium viscosity, JRS, Germany) was prepared. A system was prepared in the form of an aqueous solution with a sodium alginate concentration of 1.7% w/w based on the total weight of the aqueous solution. Subsequently, 2% w/w glycerol was added to the solution, based on the total weight of the system. The pellet was immersed in the aqueous sodium alginate solution for 10 s and dried for approx. 8 min at 50° C. in an air stream. Subsequently, the pellet was immersed a second time for 10 s in the aqueous sodium alginate solution and dried for at least 8 min at 50° C. in an air stream.

1.-15. (canceled)

16. A Compostable capsule for preparing a beverage comprising:
a core material of a bulk material, and
a cladding material encasing the core material, wherein the cladding material is a compostable, non-crosslinked polysaccharide.

17. The compostable capsule according to claim 16, wherein the compostable non-crosslinked polysaccharide of the cladding material is selected from the group consisting of starches, modified starches, pectins, celluloses, carrageenans, algin(at)s, agar, pullulan, chitin, chitosan and combinations thereof.

18. The compostable capsule according to claim 16, wherein the cladding material is composed of 1-20 layers, the layers being composed of the same or different compostable non-crosslinked polysaccharides.

19. The compostable capsule according to claim 16, wherein the capsule is home compostable according to the NF T 51-800 and AS 5810 certification schemes.

20. The compostable capsule according to claim 16, wherein the capsule is spherical in shape.

21. The compostable capsule according to claim 16, wherein the cladding material encasing the core material has no seam.

22. The compostable capsule according to claim 16, wherein the cladding material surrounding the core material has a line of weakness which facilitates opening of the capsule.

23. The compostable capsule according to claim 16, wherein the core material is selected from the group consisting of coffee powder, tea, cocoa, drinking chocolate, milk powder, instant coffee and dry soup and combinations thereof.

24. The compostable capsule according to claim 17, wherein the compostable non-crosslinked polysaccharide of the cladding material is selected from the group consisting of carboxymethylcellulose (CMC), microfibrillated cellulose (MFC), pullulan and chitosan and combinations thereof.

25. A method of manufacturing a compostable capsule comprising:
a) providing a core material from a bulk material;
b) compacting the core material into a compact;
c) providing a system comprising a compostable, non-crosslinked polysaccharide;
d) application of the system to the surface of the pressed part; and
e) drying of the coated pellet,
the process being carried out under non-cross-linking conditions.

26. The method according to claim 25, wherein the system c) is an aqueous system.

27. The method according to claim 25, wherein step d) is carried out repeatedly with the same system or different systems to produce 1-20 layers on the surface of the compact.

28. The method according to claim 25, wherein the compression of the core material is performed with a compression pressure in the range of 1-100 MPa.

29. The method according to claim 26, wherein the aqueous system is provided in the form of an aqueous solution having a concentration of compostable non-crosslinked polysaccharide between 0.1% and 30% w/w, preferably between 1% and 20% w/w, more preferably between 3% and 6% w/w, based on the total weight of the aqueous system.

30. The method according to claim 26, wherein the aqueous system additionally contains a plasticiser.

31. The method according to claim 25, wherein step e) is carried out in air flow, by convection and/or contact drying.

32. The method according to claim 25, wherein the core material is selected from the group consisting of coffee powder, tea, cocoa, drinking chocolate, milk powder, instant coffee and dry soup and combinations thereof.
